(19) United States
(12) Patent Application Publication
(10) Pub. No.: US 2016/0312918 A1
(43) Pub. Date: Oct. 27, 2016

(54) Hose Restraint System and Method for Using the Same

(71) Applicant: Caterpillar Inc., Peoria, IL (US)

(72) Inventor: Larry Teel, Sherman, TX (US)

(73) Assignee: Caterpillar Inc., Peoria, IL (US)

(21) Appl. No.: 14/691,972

(22) Filed: Apr. 21, 2015

(51) Int. Cl. F16L 3/02

(52) U.S. Cl. CPC F16L 3/02

(57) ABSTRACT

A hose restraint system to restrain a hose assembly that includes a hose and a hose coupling. A port adapter is configured to be attached to a port. An anchor member is configured to be attached to the port adapter. A sleeve is configured to be positioned over at least a portion of the hose and attached to the anchor member.

### TECHNICAL FIELD

This disclosure relates to restraint systems, and more particularly to systems and methods for restraining hose assemblies from unwanted movement.

### BACKGROUND

Various machines utilize hoses to convey material under pressure. Such material may comprise liquids, gases, and/or solids. The hoses may act as a means of transport, e.g., to move material from one place to another, or they may act to direct material to an end use. For instance, drill rigs may use hoses to transport high pressure air to flush material from newly drilled holes and to transport air to actuate hammer drills. Hydraulic equipment may use hoses to transport hydraulic fluid within a hydraulic circuit.

Fatigue may limit the useful life of a hose, and fatigue effects may concentrate near the interface between a flexible material and a less flexible material composing the hose. For example, fatigue effects may concentrate at the interface of a flexible hose and a more rigid hose coupling in a hose assembly. Secondary coupling devices have been used to restrain a flexible hose relative to a hose coupling in a hose assembly in the event that a primary, pressure-carrying or fluid-sealing coupling between the flexible hose and the hose coupling should separate.

International patent publication WO2006002459 (the '459 publication) purports to describes an example of such a device. The device in the '459 publication includes a cover that fits over a hose. The cover is secured to a hose coupling through the use of staples. The cables are attached to the cover and to fixed anchoring points located on the machine. In the event of hose failures, the cables prevent the hose from moving. One shortcoming of this approach is that it requires machines either to be manufactured with or retrofit with fixed anchoring points.

The present disclosure is directed to approaches that overcome the shortcomings in this technology area, including those relating to the device set forth in the '459 publication.

### SUMMARY

In one aspect, the disclosure is directed to a hose restraint system. An anchor member is configured to be attached to a port adapter. A sleeve is configured to be positioned over at least a portion of a hose and attached to the anchor member.

In one aspect, the disclosure is directed to a hose restraint assembly. An anchor member comprising an annular body is adapted to be axially aligned with and attached to a port of a machine. A sleeve is attached to the anchor member and configured to fit over at least a portion of a hose.

In one aspect, the disclosure is directed to a machine. The machine includes at least one port that is configured to transport a material, at least one hose assembly that is coupled to the at least one port. The at least one hose assembly includes a hose and at least one hose coupling. At least one hose restraint system restrains the at least one hose assembly. The at least one hose restraint system comprises a port adapter attached to the at least one port. An anchor member is axially aligned with and attached to the port adapter. A sleeve is positioned over at least a portion of the hose and attached to the anchor member.

### BRIEF DESCRIPTION OF THE DRAWINGS

FIG. 1 is a partial perspective view of an exemplary embodiment of an apparatus with a hose assembly and hose restraint system attached thereto;

FIG. 2 is a perspective view of an exemplary embodiment of the hose assembly and hose restraint system shown in FIG. 1; and

FIG. 3 is an exploded view of the exemplary embodiment shown in FIG. 2.

FIG. 4A is a left side view of a port adapter, according to an aspect of the disclosure.

FIG. 4B is a sectional view of a port adapter taken along section line 4-4 of FIG. 4A.

FIG. 5A is a left side view of an anchor member, according to an aspect of the disclosure.

FIG. 5B is a sectional view of an anchor member taken along section line 5-5 of FIG. 5A.

FIG. 6 is a sectional view of the port adapter, the anchor member, and a sleeve shown in engagement.

### DETAILED DESCRIPTION

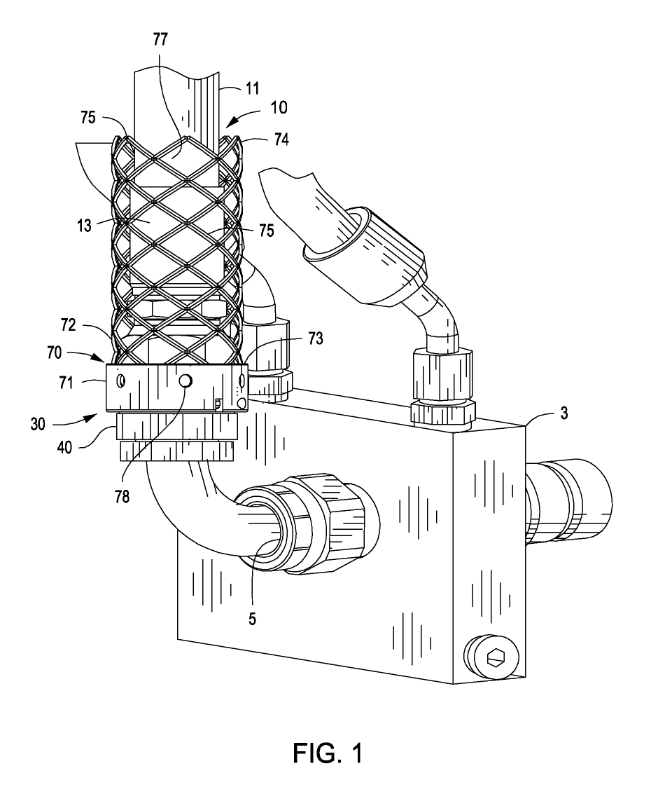

Referring to FIG. 1, a partial view of an exemplary apparatus 1 is provided for illustrative purposes. The apparatus 1, in one example, comprises a machine, a tool, or a device that includes a housing 3 and one or more instances of a port 5. The port 5 in one example is utilized to transport a working material, such as a gas, a solid, or a liquid. One example of an apparatus 1 is a blast hole drill rig that uses air at high pressure to flush drilled material out of drilled holes and/or to actuate hammer drills. Another example of an apparatus 1 is a hydraulic machine that uses hydraulic fluid to actuate hydraulic cylinders to move various implements of the hydraulic machine. The preceding examples are provided for exemplary purposes only. It will be understood that the apparatus 1 may include any device that contains at least one port 5 for transporting material (e.g., hydraulic systems, pneumatic systems, etc.)

Referring further to FIG. 1, at least one hose assembly 10 is shown attached to the port 5. The hose assembly 10 may be used to transport material under pressure to or from the port 5. In the event of inadvertent separation, a hose restraint system 30 is provided to restrain the hose assembly 10 and prevent unintended movement thereof.

Referring further to FIG. 1, an exemplary description of the configuration of the hose assembly 10 and the hose restraint system 30 will be provided for illustrative purposes. In one embodiment, the hose assembly 10 comprises a hose 11 and a hose coupling 13. The hose coupling 13 is utilized to connect the hose 11 to the port 5. In one embodiment, the hose restraint system 30 comprises a port adapter 40 and a hose restraint assembly 70. In one example, the hose assembly 10 and the hose restraint assembly 70 are each connected to the port adapter 40, and are thereby each connected to the port 5.

It should be noted that the preceding configuration is provided for illustrative purposes only and therefore other configurations are within the scope of this disclosure. For instance, the hose restraint assembly 70 may be connected directly to port 5 through another mechanism rather than the port adapter 40. In another example, the features of port adapter 40 may be combined with port 5 and thereby allow for the direct connection of the hose restraint assembly 70 to the port 5. The port adapter 40 may be made from a number of materials, including, but not limited to, metals, metal alloys, plastic materials, or combinations thereof.

Referring further to FIG. 1, the hose restraint assembly 70 in one example comprises an anchor member 71 attached to a sleeve 72. The anchor member 71 in one example is an annular body that is configured to fit around the hose coupling 13 and the port adapter 40. The anchor member 71 is adapted to be secured to the port adapter 40. It should be noted that the anchor member 71 is described as an annular body for illustrative purposes only and that alternative embodiments of the anchor member 71 are possible. For instance, the anchor member 71 may comprise other geometric shapes. Further, the anchor member 71 may be made from a number of materials, including, but not limited to, metals, metal alloys, plastics, and combinations thereof.

Referring further to FIG. 1, the sleeve 72 in one example is configured to hold at least a portion of the hose assembly 10. In one embodiment, one end 73 of the sleeve 72 is attached to the anchor member 71 and another end 74 of the sleeve 72 is positioned adjacent to an intermediate portion of the hose assembly 10, such as a portion of the hose 11. In another embodiment, one end 73 of the sleeve 72 is attached to the anchor member 71 and another end 74 of the sleeve 72 is attached to another port 5. In the preceding embodiment, the other end 74 of the sleeve 72 may be attached to the other port 5 through use of another adapter 40 and anchor member 71.

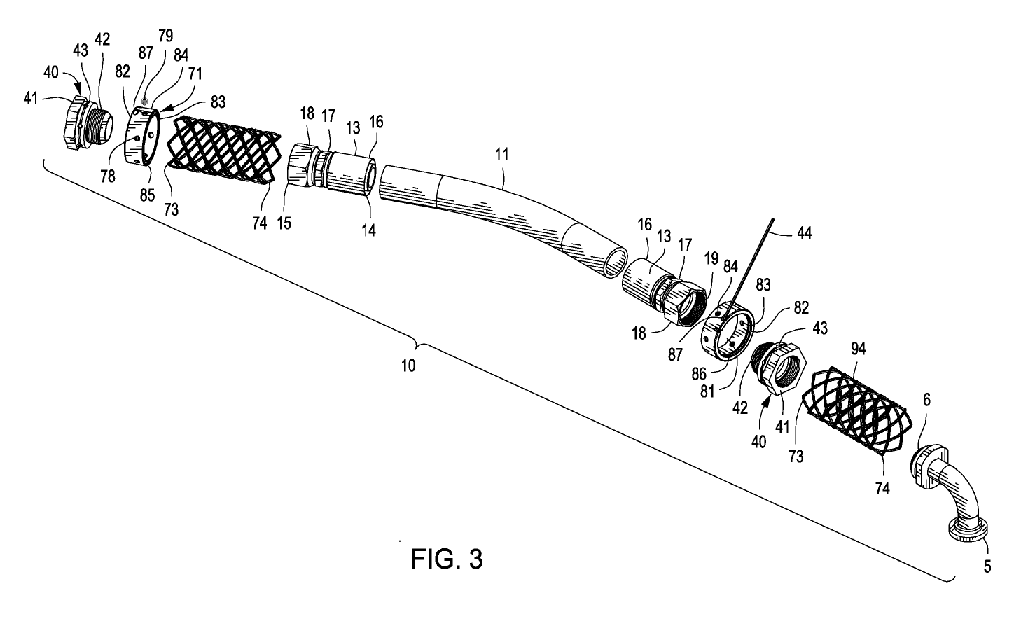

Referring further to FIG. 1, in one embodiment the sleeve 72 is made of a woven material. For example, the sleeve 72 may be woven from a metal, such as galvanized steel. In another example, the sleeve 72 may be woven from twisted-pair metal wire. Each sleeve 72 may comprise a plurality of strands 75. Multiple strands 75 intersect to define openings 77. In one example, the openings 77 may be diamond shaped. In another example, the openings 77 may be utilized to connect anchor member 71 to sleeve 72. For instance, the anchor member 71 may have openings 78 through which fasteners 79 (see FIG. 3) may be inserted. The fasteners 79 may be positioned within openings 78 and in engagement with the sleeve 72 to secure the sleeve 72 and the anchor member 71 together.

In the event of an inadvertent separation, the character of sleeve 72 may cause the sleeve 72 to grip onto the hose assembly 10. For example, the force exerted on the sleeve 72 by the hose assembly 10, as the hose assembly 10 pulls away from the port 5, will pull at the strands 75 and may cause the sleeve 72 to tighten. It should be noted that the sleeve 72 is described as woven for illustrative purposes. Other embodiments of the sleeve 72 are within the scope of the present disclosure. The sleeve 72 may be of open form, or it may be of closed form so as to prevent the ejection of material from the hose assembly 10 in the event of an inadvertent separation. As noted, the sleeve 72 may be made of wire, but it may also be made of other materials, including but not limited to, textile material and synthetic materials, such as nylon. The sleeve 72 may be made of any suitable material to restrain all or at least a portion of hose assembly 10 if it should fail.

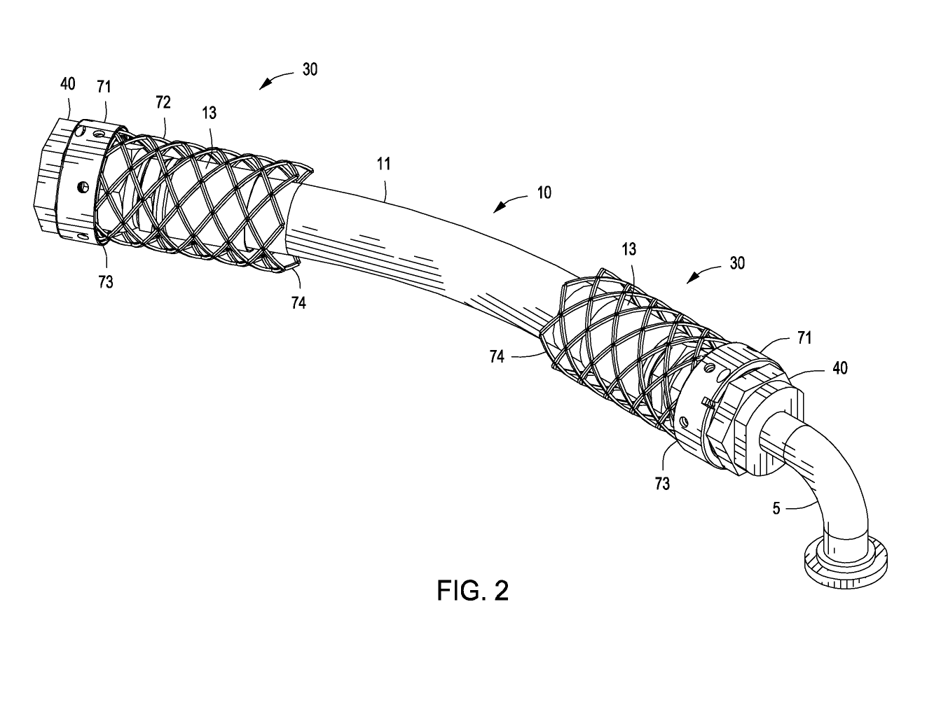

Referring now to FIG. 2, an exemplary configuration of a hose assembly 10 and a hose restraint system 30 is shown for illustrative purposes. A hose coupling 13 is shown attached at both ends of a hose 11. One hose coupling 13 is shown as attaching hose 11 to one port 5. In another embodiment, each end of the hose 11 may be attached to a port 5. A hose restraint system 30 is shown positioned at each end of the hose assembly 10. However, it will be understood that the hose restraint system 30 may be used only at a single end of the hose assembly 10. Further, each hose restraint system 30 could include a sleeve 72 attached at one end 73 to the port 5 and positioned adjacent an intermediate portion of the hose 11 at another end 74. The other end 74 may be either attached or unattached to the hose 11. If the other end 74 were attached, such attachment may be accomplished through the use of a connector, such as a clamp, staples, etc. In another alternative, a single sleeve 72 may connect to a first port 5 and extend to a second port 5 to which the single sleeve 72 is also connected. In such an embodiment, the sleeve 72 may be attached to each port 5 by utilizing a port adapter 40 and an anchor member 71.

FIG. 3 shows an exploded view of the hose assembly 10 and hose restraint system 30 shown in FIG. 2, according to an aspect of the disclosure. In one example, each hose coupling 13 comprises a hose connection end 14 and an equipment connection end 15. The hose connection end 14 in one example comprises a shell 16 within which the hose 11 is inserted and attached through a method, such as crimping or swaging. The hose connection end 14 and the equipment connection end 15 may also include a stem 17. In one example, the shell 16 and the stem 17 may form an annular space within which the hose 11 may be inserted such that the stem 17 is positioned in the hose 11.

At the equipment connection end 15, a nut 18 may rotate around, or with respect to, the stem 17. The nut 18 may include a threaded interior surface 19 that is adapted to engage with a threaded exterior surface of a male member, such as a portion of port adapter 40, so that the hose assembly 10 may be connected thereto. It should be noted that the preceding description of the hose assembly 10 is provided for illustrative purposes only and other examples are encompassed by the present disclosure. For instance, hose coupling 13 may include various other types of connectors that are used to connect hoses to equipment.

Referring further to FIG. 3, the port adapter 40 in one embodiment comprises a fitting including a first end 41 that is configured to attach to port 5 and a second end 42 that is configured to attach to the equipment connection end 15 of the hose coupling 13. In one example, the first end 41 may include a threaded female coupling and the second end 42 may include a threaded male coupling. In one embodiment, the port adapter 40 includes a channel 43 that is utilized to attach port adapter 40 to anchor member 71. In a further example, a pin 44 is used in conjunction with channel 43 to secure port adapter 40 to anchor member 71, as will be further described herein.

Referring further to FIG. 3, the anchor member 71 in one example comprises an annular body defining an opening 81. The annular body is adapted to be axially aligned with and attached to the port adapter 40. The annular body includes a first edge 82, a second edge 83, and a mediate portion 84. In one example, the opening 81 is dimensioned such that the second end 42 of the port adapter 40 and the equipment connection end 15 of the hose coupling 13 may fit within the opening 81, such that the anchor member 71 may surround at least a portion of the equipment connection end 15 of the hose coupling 13 and the second end 42 of the port adapter 40. In one example, the anchor member 71 defines a space 85, or groove, adjacent to the second edge 83 of the anchor member 71 to receive one end 73 of the sleeve 72. In one example, the space is an annular channel that extends axially from the second edge 83. The one or more openings 78 are positioned in the mediate portion 84 of the anchor member 71 and extend through the anchor member 72 in the radial direction. The one or more openings 78 are each dimensioned to receive one of the fasteners 79, such as a dowel, a screw, or a pin, that may be inserted within the openings 78 to engage the sleeve 72 and secure the sleeve 72 to the anchor member 71. In one example, the fasteners 79 each engage an intersection 94 of the strands 75 to secure the end 73 of the sleeve 72 to the anchor member 71.

Referring further to FIG. 3, the anchor member 71 in one example includes a channel 86 on an inner surface thereof. In one example, the channel 86 is configured to be in registration with the channel 43 on the exterior surface of the port adapter 40 when the anchor member 71 is positioned over the port adapter 40. According to an aspect of the disclosure, registration of the channel 43 and the channel 86 includes alignment of the channel 43 and the channel 86 along a longitudinal axis of the hose assembly 10. Another opening 87 extends through an exterior surface of the anchor member 71 and is in communication with the channel 86. The pin 44 may be inserted through opening 87 and positioned within the channel 43 and the channel 86, thereby securing the port adapter 40 and the anchor member 71 together. In one example, at least one of the channel 43, the channel 86, and the pin 44 are rectangular.

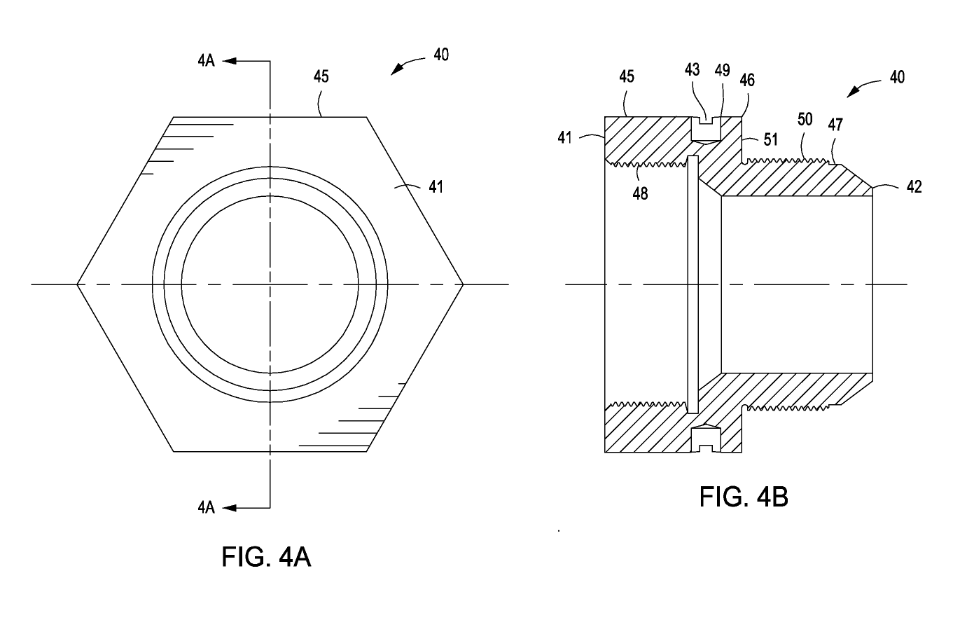

Referring to FIG. 4A, an end view of the port adapter 40 is provided for illustrative purposes. Referring to FIG. 4B, a sectional view taken along line 4-4 of FIG. 4A is also provided for illustrative purposes. Referring now to FIGS. 4A and 4B, in one example, the port adapter 40 includes an engagement portion 45, a first cylindrical portion 46, and a second cylindrical portion 47. The engagement portion 45 in one example (see FIG. 3) includes an outer surface configured (e.g., hexagonal) such that a tool may be used to grip the port adapter 40 when connecting the port adapter 40 to the port 5. The engagement portion 45 in a further example includes a threaded inner surface 48 to engage with a threaded outer surface 6 (e.g., of port 5). The first cylindrical portion 46 has an outer surface 49 that seats and connects with the hose restraint assembly 70 as will be further discussed herein. The second cylindrical portion 47 may have a threaded outer surface 50 for connecting to the equipment connection end 15 of the hose coupling 13. In one example, the circumference of the threaded outer surface 50 of the second cylindrical portion 47 is less than the circumference of the outer surface 49 of the first cylindrical portion 46 to create a flange 51 for the hose coupling 13 to abut when the equipment connection end 15 of the hose coupling is connected to the port adapter 40. Referring further to FIG. 4, in one example the outer surface 49 of first cylindrical portion 46 includes the channel 43. In one example, the cross sectional shape of the channel 43 is generally rectangular. In one example, the channel 43 extends circumferentially generally around the first cylindrical portion 46 and radially inward from the outer surface 49. The channel 43 may be utilized to connect the port adapter 40 to the hose restraint assembly 70 as discussed previously in connection with FIG. 3.

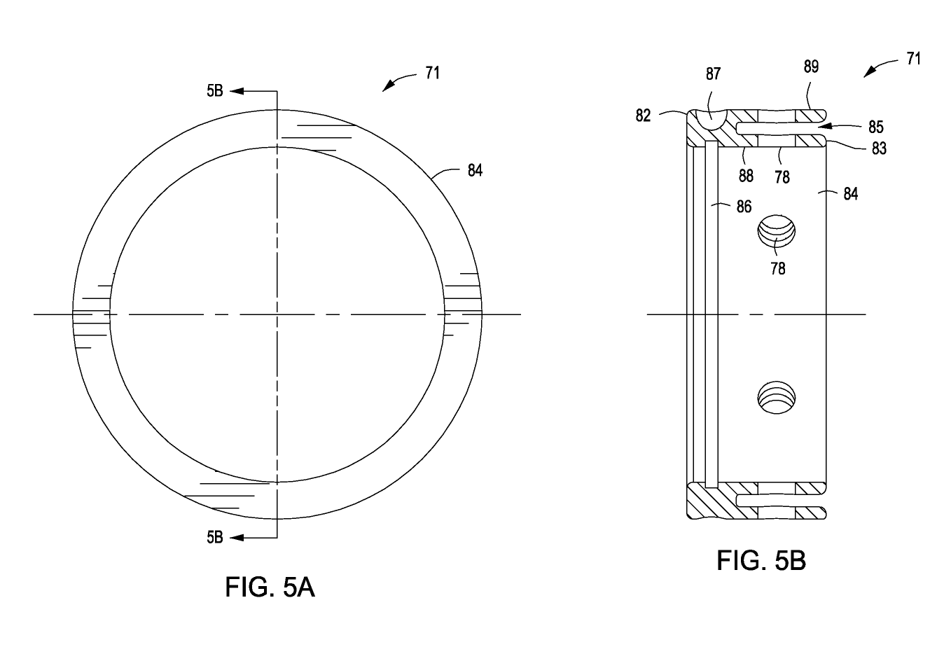

Referring to FIG. 5A, an end view of the anchor member 71 is provided for illustrative purposes. Referring to FIG. 5B, a sectional view taken along line 5-5 of FIG. 5A is also provided for illustrative purposes. Referring now to FIGS. 5A and 5B, in one example, the anchor member 71 includes the first edge 82, the second edge 83, and the mediate portion 84 positioned between the first edge 82 and the second edge 83. The mediate portion 84 includes an inner surface 88 and an outer surface 89. The channel 86 extends radially outwardly from the inner surface 88. In one example, the cross sectional shape of the channel 86 is generally rectangular. In another example, the channel 86 extends over the circumference of the inner surface 88.

Referring further to FIG. 5, the openings 78 in one embodiment are positioned in the mediate portion 84 of the anchor member 71. The openings 78 in one example extend from the inner surface 88 to the outer surface 89. The openings 78 in the embodiment shown in FIG. 5 are shown as circular, but other geometric configurations are contemplated to be within the scope of this disclosure. In one example, the fasteners 79 (FIG. 3), which may be positioned in openings 78, are pins or dowels that may be press fit into the openings 78. In another example, the openings 78 and the fasteners 79 may be threaded.

Referring further to FIG. 5, the space 85 for receiving the sleeve 72 is positioned between the inner surface 88 and the outer surface 89. The space 85 in one example extends from the second edge 83 toward the first edge 82 and terminates prior to the first edge 82 within the mediate portion 84. In one example, the space 85 extends around the circumference of the inner surface 88 of the anchor member 71. The space 85 is shaped and dimensioned to receive the sleeve 72. One or more of the openings 78 are in communication with space 85 such that the sleeve 72 may be secured to the anchor member 71 through one or more of the fasteners 79 that are positioned in the space 85 through the one or more openings 78.

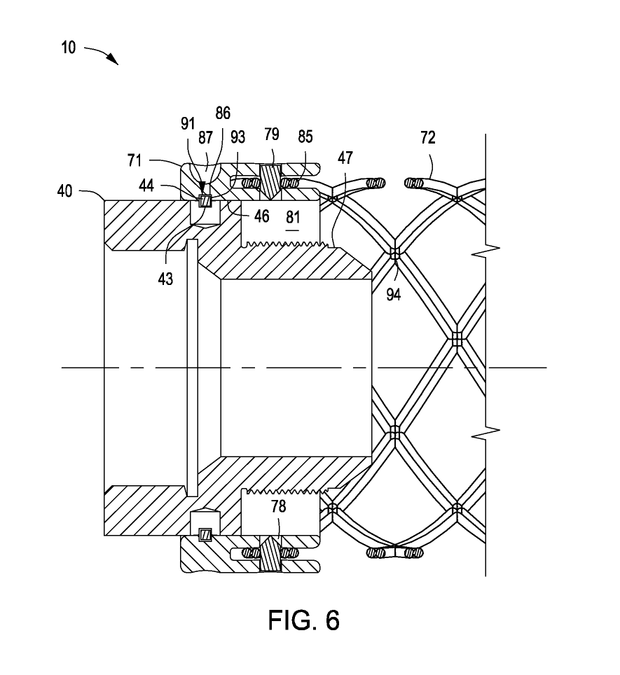

Referring now to FIG. 6, a sectional view of the port adapter 40, the anchor member 71, and the sleeve 72 is shown for illustrative purposes. In one example, the anchor member 71 is positioned over the port adapter 40 such that the first cylindrical portion 46 and at least a portion of the second cylindrical portion 47 of the port adapter 40 are positioned within the opening 81 of the anchor member 71. The channel 43 of the port adapter 40 and the channel 86 of the anchor member 71 are in registration. According to an aspect of the disclosure, registration between the channel 43 and the channel 86 includes alignment of the channel 43 and the channel 86 along a longitudinal axis of the hose assembly 10. Accordingly, the channel 43 and the channel 86 may form a combined channel 91 having sidewalls 93.

The pin 44 in one example is made of metal. In one example, the metal is sufficiently flexible to be inserted into the combined channel 91, but is sufficiently rigid to secure the port adapter 40 and the anchor member 71 together. The pin 44 is inserted through the opening 87 and positioned around and within the combined channel 91. The pin 44 then bears against the sidewalls 93 of the combined channel 91 and secures port adapter 40 to anchor member 71. The fasteners 79 are positioned within the openings 78 to engage the sleeve 72. In one example, at least one fastener 79 is press fit within one of the openings 78 and extends through the space 85. In another example, at least one of the fasteners 79 is positioned within at least one of the openings 77 of the sleeve 72. In the event of inadvertent separation of the hose assembly 10 from the port 5, at least one of the fasteners may engage at least one of the intersections 94 of strands 75 to secure the sleeve 72 within the space 85.

### INDUSTRIAL APPLICABILITY

Referring to FIG. 1, an exemplary method of restraining a hose assembly 10, attached to a port 5, using the hose restraint system 30 will be provided for illustrative purposes. Referring now to FIG. 3, in one example, the port 5 includes a male connector with a threaded outer surface 6. The port adapter 40 comprises a threaded female connector at a first end 41 and a threaded male connector at a second end 42. The first end 41 of the port adapter 40 is connected to the port 5 by rotating and engaging the port adapter 40 with the outer surface 6. The sleeve 72 of the hose restraint assembly 70 is positioned over at least a portion of the hose assembly 10. One end 73 of the sleeve 72 is attached to the anchor member 71. The other end 74 of the sleeve 72 is positioned adjacent to an intermediate portion of the hose assembly 10, such as the hose 11. In another embodiment, the other end 74 of the sleeve 72 is attached to a second anchor member 71 that is attached to a port 5.

The equipment connection end 15 of the hose coupling 13 is attached to the male connector at the second end 42 of the port adapter 40. The anchor member 71 is axially aligned with and attached to the port 5 by positioning the anchor member 71 over the port adapter 40 such that the channel 43 of the port adapter 40 is in registration with the channel 86 of the anchor member 71. The pin 44 is inserted into opening 87 and is inserted into the combined channel 91 (FIG. 6). Accordingly, if hose assembly 10 were to inadvertently separate from port 5, the hose restraint system 30 would prevent hose assembly 10 from moving in an undesirable manner.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A hose restraint system, comprising:
a port adapter;
an anchor member that is configured to be attached to the port adapter; and
a sleeve that is configured to be positioned over at least a portion of a hose and attached to the anchor member.

2. The hose restraint system of claim 1, wherein the anchor member comprises an annular body including a first edge, a second edge, and a mediate portion positioned between the first edge and the second edge, and wherein the port adapter and the sleeve are configured to be attached to the mediate portion.

3. The hose restraint system of claim 2, wherein the annular body further comprises an inner surface, an outer surface, and a space defined by the inner surface and the outer surface, configured to receive at least a portion of the sleeve, which is positioned between the inner surface and the outer surface and which extends from the second edge towards the first edge.

4. The hose restraint system of claim 3, wherein the space extends circumferentially about the annular body.

5. The hose restraint system of claim 3, wherein the mediate portion of the annular body defines at least one opening, extending from the outer surface to the inner surface, and wherein the at least one opening is configured to receive a fastener to secure the sleeve to the anchor member.

6. The hose restraint system of claim 5, wherein the sleeve comprises a material including a first plurality of strands and a second plurality of strands that intersect to define a plurality of openings configured to receive the fastener.

7. The hose restraint system of claim 3, wherein the port adapter comprises a first end adapted to be attached to a hose coupling, a second end adapted to be attached to a port, and an intermediate portion positioned between the first end and the second end, and wherein the intermediate portion includes an outer surface defining a first channel.

8. The hose restraint system of claim 7, wherein the inner surface of the anchor member defines a second channel, and wherein the first channel and the second channel are configured to be in registration when the anchor member is positioned around the port adapter.

9. The hose restraint system of claim 8, wherein the first channel and the second channel are both rectangular and are configured to receive a pin to secure the anchor member to the port adapter.

10. The hose restraint system of claim 7, wherein the first end of the port adapter comprises a male coupling and the second end comprises a female coupling.

11. A hose restraint system, comprising:
an anchor member comprising an annular body that is adapted to be axially aligned with and attached to a port of a machine; and
a sleeve attached to the anchor member and configured to fit over at least a portion of a hose.

12. The hose restraint system of claim 11, wherein the annular body further comprises:
a first edge, a second edge, and a mediate portion positioned between the first edge and the second edge, and wherein the sleeve is attached to the anchor member at the mediate portion.

13. The hose restraint system of claim 12, wherein the annular body includes an inner surface, an outer surface, and a space defined by the inner surface and the outer surface, positioned between the inner surface and the outer surface, which extends from the second edge and terminates within the mediate portion.

14. The hose restraint system of claim 13, wherein at least a portion of the sleeve is positioned within at least a portion of the space.

15. The hose restraint system of claim 13, wherein the mediate portion defines at least one opening that extends through from the inner surface to the outer surface and is in engagement with the sleeve.

16. The hose restraint system of claim 15, wherein the sleeve is attached to the annular body through a fastener positioned within the at least one opening and in engagement with the sleeve.

17. The hose restraint system of claim 11, wherein the anchor member is configured to be attached to a port of a machine through a port adapter.

18. A machine, comprising:
at least one port that is configured to transport a material;
at least one hose assembly that is coupled to the at least one port, wherein the at least one hose assembly includes a hose and at least one hose coupling; and
at least one hose restraint system to restrain the at least one hose assembly, wherein the at least one hose restraint system comprises:
a port adapter attached to the at least one port;
an anchor member comprising an annular body that is axially aligned with and attached to the port adapter; and
a sleeve that is positioned over at least a portion of the hose and attached to the anchor member.

19. The machine of claim 18, wherein the annular body comprises a first edge, a second edge, and a mediate portion, which includes an inner surface and an outer surface positioned between the first edge and the second edge, and wherein the annular body includes a space defined by the inner surface and outer surface in which at least a portion of the sleeve is positioned and secured to the annular body.

20. The machine of claim 19, wherein the port adapter and the anchor member include means for securing the port adapter and the anchor member together.
